(19) United States
(12) Patent Application Publication
(10) Pub. No.: US 2005/0211644 A1
(43) Pub. Date: Sep. 29, 2005

(54) Mixed bed trickling reactor using microbeads

(75) Inventor: Joshua N. Goldman, Montague, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Aquatic Advisors, LLC, Montague, MA (US)

(21) Appl. No.: 11/087,428

(22) Filed: Mar. 23, 2005

Related U.S. Application Data
(60) Provisional application No. 60/555,830, filed on Mar. 24, 2004.

(51) Int. Cl. C02F 1/00

(52) U.S. Cl. 210/786

(57) ABSTRACT

A filter system with a deep bed filter of microbeads is provided. The filter system may include a mixed bed trickling filter that utilizes microbeads as a high specific surface area media for biofiltration, capture of fine particulate solids, as well as degassing and oxygenating. Mixing devices, such as mechanical stirrers, axial flow pumps, airlift pumps or helical screws, may be integrated to enhance the mixing of the bed and to prevent clogging. Degassing or oxygenating process may be integrated within the microbead filter to introduce or withdraw gases in the bed. In a particular embodiment, the filter system includes serial distribution plates, which support multi-layered beds that create separate chambers in a filter vessel. Degassing or oxygenation process may be integrated within each microbead filter chamber.

### RELATED APPLICATION

This application claims the benefit of U.S. Provisional Application No. 60/555,830, filed on Mar. 24, 2004, the entire teachings of which are incorporated herein by reference.

### BACKGROUND

Worldwide demand for fish and marine food products is steadily increasing, both as a result of population increases and because of an increasing preference for marine-based protein. Simultaneously, a significant portion of the world's natural fishery resources are depleted due to over-fishing and environmental degradation. In an effort to overcome the depleted natural fish resources, fish farms are being implemented.

Current fish farming techniques use flow through facilities, ponds and net pens. These techniques, however, face a number of shortcomings, including environmental and production constraints. The seafood stock, for example, is often vulnerable to disease, pollution, and other potential environmental problems. Many facilities require very high water consumption, sometimes requiring exchange rates in excess of 10,000 gallons per pound of fish produced. This water requirement negatively impacts the environment and imposes site, scale and economic restrictions.

A system offered by Aquatic Advisors, LLC, overcomes at least a portion of the above problems by permitting the fish or other seafood to be grown within a controlled environment. This controlled environment includes a closed loop system with one or more tanks, through which water flows at a selected rate. Most of the water that leaves the tank is purified using water reuse technologies that include biological filtration, degassing, and oxygenation processes, before being returned to the tank. With this closed loop system, a fish farming approach can be provided that dramatically reduces water usage and protects the seafood stock from disease, pollution and other potential environmental problems. In addition, product availability and product diversity can remain independent from the local environment, land resources can be used efficiently, and the farm can be located in a relatively inexpensive location. Waste can also be collected and utilized as manure to increase profitability.

While this approach addresses many of the shortcomings of traditional fish farms, it is dependent on water reuse technologies. Unfortunately, existing water reuse systems are often expensive to build and operate. They are also subject to various technical problems that have limited their application. Water reuse systems generally segment the various water treatment component processes into distinct stages, with each stage generally requiring a separate vessel as well as piping connections and control valves to adjust and control the treatment effect of each sequential stage. Major component water treatment process involved in maintaining water quality within recirculating aquaculture systems typically include: (i) course solids removal, (ii) biofiltration, (iii) degassing (iv) oxygenation, (v) disinfection, and (vi) fine solids removal. Because these systems typically circulate very large volumes of water, it is critically important that each component process and the integration of these processes be as efficient as possible.

Biological filters are considered the core of a water reuse system utilized for recirculating aquaculture. Biofilters help maintain water quality in recirculating and are used to improve water quality before water is discharged from a facility. The design and operational characteristics of biofilters are among the most important factors that determine the success or failure of an aquaculture operation. Considerable efforts have been expended over the last decade to develop cost-effective biofilters optimized for the unique kinetic and economic realities of recirculating aquaculture.

Void fraction is a key component used to evaluate filter performance. Void fractions rationally vary from 15% to 90%. Plugging, the blocking of water flow through a filter bed, is often a very serious problem for biofilters. The high-density areas of the filter bed can become plugged and inoperable while the rest of the bed experiences channeling or localized high flow regions. This can lead to major decreases in filter performance.

Specific surface area is another key measure to evaluate filter performance. Specific surface area is how much biologically active area is contained within a given volume. Specific surface areas vary widely but generally traditional filter packing materials will provide between 30 and 250 sq. ft./cu. ft. Surface area that is not subject to active flow conditions may be limited in its effectiveness due to diffusion limits in the exchange of one or more critical substrates. Further, as a biofilter matures, the biofilm typically becomes thicker and can negatively affect treatment process efficiency. The total surface area available for bacterial growth is a useful predictor of the capacity of the biofilter to convert ammonia, oxidize BOD or remove Nitrate under anoxic conditions. The specific surface area also influences the cost of the biofilter vessel and support mechanisms.

Fluidized bed reactors provide a very high specific surface area for a biofilm attachment. They also provide high hydraulic loading and are generally self-cleaning. Unfortunately, they are costly to construct and require significant amounts of energy to fluidize the heavy media.

Small buoyant plastic bead filters also provide significant specific surface area. The small size of the beads provides a relatively large surface area per unit volume. Bead filters usually consist of a closed vessel partially filled with small beads of plastic. The vessel is typically filled with water and the beads float at the top to create a moving filter bed.

Up flow buoyant bead filters have been developed to move water up through the filter bed; thereby capturing solids. Continuous removal of the bottom layer of the media, cleaning and reintroduction at or near the top of the filter bed can accomplish backwashing. Air bubbles may also be used to backwash the bed.

Other bead filters allow the media in the filter bed to move in the same direction as the flow of liquid being filtered. The buoyancy of the media and the pressure drop across the outlet screens continuously force the bed past the discharge screen to a level where the media can be removed by a scraper mechanism.

The more sophisticated bead filter systems incorporate mechanical stirring devices such as a propeller on a shaft. At regular intervals, the water flow is shut off and the media bed is stirred to dislodge the suspended solids. The solids are allowed to settle into the bottom of the vessel and then drained off.

Although bead filters provide large cumulative surface area, they are often susceptible to clogging, an inability to effectively backwash the filter media, and excessive head loss. Overly frequent washing to remove solids dislodges the biofilm and disrupts the nitrification process. Not washing the beads enough, however, clogs the bed. High head loss is a problem because pressure is required to push water through the filter. The pressure required to maintain a constant flow rate increases as the voids become filled with solids. This leads to cyclic rather than constant performance. The technical literature on submerged buoyant media filters specifies that maximum bed depths of <15 cm are required to avoid these problems.

A microbead disbursing design has been developed involving the downward fluidization of plastic microbeads. Specifically, U.S. Pat. No. 5,747,311 to Jewell et al., describes buoyant plastic microbeads dispersed within in a dispersing fluid, which downwardly fluidizes the media. The very large difference in specific gravity between the buoyant media and the dispensing fluid, coupled with the small size of the media particles, requires shallow (<0.3 Meter) bed depths and very high flow rates (typically 35 gpm/Ft²) to prevent channeling. Shallow bed depths, however, limit removal of excess biofilm and fine particles that are captured within the bed and negatively impact the efficiency if the biofilter is integrated with other water treatment component process, e.g. CO₂ removal and oxygenation. In addition, fluidization with acceptable levels of channeling will only occur within a narrow range of hydraulic loading, which further limits the flexibility in efficiently integrating filtration with other water treatment component process.

A floating microbead filter has been described by Greiner et al., “Evaluation of the nitrification rates of microbead and trickling filters in an intensive recirculating tilapia production facility,” Aquacultural Engineering, September 1998, vol. 18, no. 3, pp. 189-200, that uses microbeads for nitrification of aquaculture water within a recirculation system. A shallow bed (≈18 cm or 7″) is floated on water within a conical bottom filter tank. The influent is distributed over the media such that the filter operates in a trickling mode. Relatively high hydraulic loading rates, (22-45 gpm/Ft²) cause some downward fluidization of the media.

While the floating microbead filter achieves a very high specific surface area with reduced energy costs, the design suffers from several limitations. Specifically, as is the case with the up flow buoyant bead filters and with Jewell's microbead disbursing design, only very shallow bed depths work. Consequently, the limited void space between the media particles captures and retains solids, and the hydraulic forces used are insufficient to mobilize and remove these solids in beds deeper than 7″-15″.

### SUMMARY

The filters described above do not provide a cost-effective, comprehensive and versatile solution to water treatment. The conventional filters are not optimized for the unique kinetic and economic realities of recirculating water systems. The shallow bed depth of the conventional filter systems limits the removal of excess biofilm and fine particles that are captured within the bed, increases filter cost, necessitates higher turnover rates, and limits the flexibility in integrating the biofiltration with other component water treatment processes. Conventional microbead filtration systems are limited to bed depths of <0.5 meters because bed depths greater than 0.5 meters typically result in clogging and biofouling, which reduces performance. Consequently, in such systems the media needs to be changed every 9-12 months.

Particular embodiments of the invention relate to a filter with a deep bed of microbeads, which may be integrated with multiple water treatment processes. The deep bed microbead filter may be integrated with other processes that perform the biologic filtering, aeration, and degassing functions. By integrating these processes and creating a deep bed filter of microbeads, the cost of water treatment and reuse can be reduced, and process kinetics and efficiency can be improved.

The deep bed microbead filter, for example, may have a bed depth of at least 0.5 meters. Use of a deep filter bed of microbeads can effectively balance the area of the gas:liquid interface to remove dissolved CO₂ with the biologically active surface area to undertake bioconversion processes, such as the oxidation of ammonia to nitrate. This balance between the treatment effect of multiple component water treatment process performance can be key to the effective nitration of what have historically been independent treatment steps undertaken in discrete, specialized processes.

In one embodiment, a filtration device includes a vessel with a deep bed filter of microbeads. The microbeads are capable of filtering a fluid that passes through the vessel. A mixing device, which is within the vessel, is capable of mixing the microbeads. A distribution device is provided that distributes the fluid into the deep bed filter.

The deep bed filter may include an exchange device that exchanges gases in the fluid. The exchange device may include a degassing system. The degassing system may include a spray tower, drip tower or packed tower. The exchange device may include an oxygenation system. The exchange device may include a recovery device, which recovers residue derived from the fluid.

The distribution device may include serial distribution plates, which support the deep bed filter. The distribution plates may be modified to provide substantially uniform flow of the fluid through the deep bed filter.

The mixing device may include a stirrer, axial flow pump, airlift pump or helical screw. The mixing device can be modified to prevent blockage of the fluid in the deep bed filter.

In another embodiment, a method of filtering a fluid is provided using a deep bed filter of microbeads. The microbeads in the deep bed filter are mixed. The fluid is distributed through the deep bed filter of microbeads to provide a filtered fluid. When the fluid is distributed through the deep bed filter of microbeads, gases may be exchanged in the fluid, which cause gases to be removed from the fluid. The removal of gases from the fluid may capture particles or biomass from the microbeads. The particles or biomass from the microbeads may be captured using a rinsing system. The exchange of gases in the fluid may cause residue from the fluid to be recovered. The microbeads in the deep bed filter may be mixed with a stirrer or a pump. The stirrer or pump can move the microbeads around the deep bed filter. In this way, blockage of the fluid in the deep bed filter may be prevented.

In another aspect, a deep bed filter is provided that includes a plurality of separation elements. The deep bed filter may have a housing containing the separation elements. The separation elements may divide the interior of the housing into chambers. The chambers may be stacked in the housing. Each chamber may support a filter bed of microbeads. A fluid may pass through one or more of the filter beds of microbeads to provide deep bed filtration.

In another aspect, a method of filtering a fluid is provided that has multiple layers of microbead filter beds in a filter housing. A separation element may be positioned between each layer of microbead filter beds. A fluid may be passed through one or more of the microbead filter beds to provide deep bed filtration.

The foregoing and other objects, features and advantages of the invention will be apparent in the following more particular description of preferred embodiments of the invention as illustrated in the accompanying drawings.

### BRIEF DESCRIPTION OF THE DRAWINGS

FIG. 1 is a schematic depicting a microbead filter incorporating an airlift or axial flow pump.

FIG. 2 is a schematic depicting a microbead filter with a helical mixer.

FIG. 3 is a schematic depicting a microbead filter with a paddle mixer.

FIG. 4 is a schematic depicting a microbead filter with stacked plates.

### DETAILED DESCRIPTION OF THE INVENTION

A description of preferred embodiments of the invention follows.

In recirculating production systems, especially those systems for use in connection with aquaculture, a water treatment system should be in place to oxidize ammonia and nitrite-nitrogen, remove carbon dioxide, aerate or oxygenate the water and remove wastes solids from the water before returning it to the tanks. Preferably, a single integrated filter unit is used to perform the biologic filtering, aeration and degassing functions.

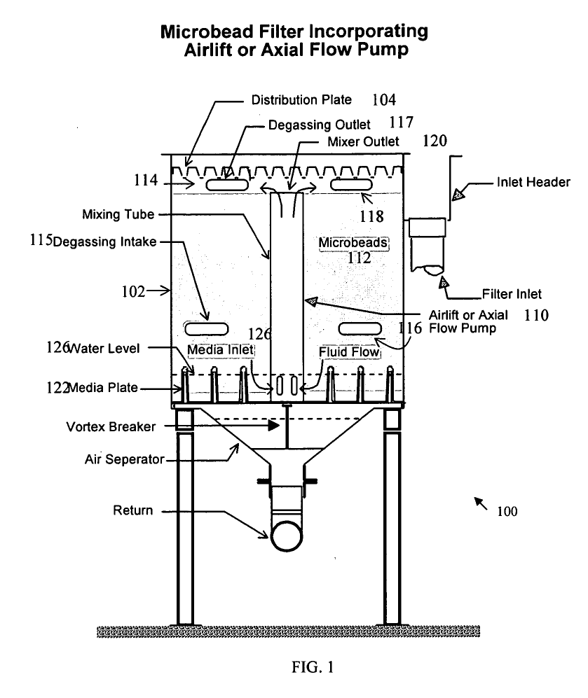

FIG. 1 is a schematic depicting a microbead filter 100 incorporating an airlift or axial flow pump 110. The filter system 100 is contained within a waterproof vessel 102, normally constructed of plastic, steel or fiberglass. The fluid to be filtered (typically water containing dissolved and particulate pollutants) enters toward the top of the filter vessel and flows across a distribution plate 104.

The fluid is distributed across the distribution plate 104, which contain multiple nozzles or perforations. The distribution plate 104 sprays or otherwise distributes the fluid uniformly over the filter bed 112. For example, a spray tower, drip tower or packed tower may be used. The distribution plate 104 also serves a role in the removal of solids from the media 112.

Airspace below the distribution plate 104 and above media 112 is normally incorporated to function as a plenum 114. In connection with the specific surface area provided by the media bed 112, the plenum 114 facilitates efficient distribution and allows air or other gases to be introduced or withdrawn. Unwanted dissolved gasses, typically CO₂, may be removed. Desirable gases, typically oxygen, can be introduced. One or more screened intake ports 115, 116 are located substantially toward the bottom of the filter bed 112. The intake ports 115, 116 introduce air and provide an oxygenation system. One or more exhaust ports 117, 118 are located within the plenum 114 above the filter bed 112. The exhaust ports 117, 118 draw air from the filter vessel 102 and provide a degassing system. By integrating the ports 115, 116 through which an oxygen-containing gas is introduced into the microbead bed 112, undesirable gases can be displaced and, thus, removed using the exhaust ports 117, 118. In this way, aeration and degassing can be accomplished.

After flowing through the plenum 114, the fluid trickles down through the media bed 112, and passes through the void spaces between the individual microbeads. Preferably, the microbeads are positively buoyant spherical particles made of expanded or unexpanded polystyrene Styrofoam™ beads, ranging in size from 0.3 to 3 mm in diameter. The microbeads may be any other material that adequately filters a contaminated water supply. This media provides a specific surface area of between X to Y M2/M³. The flow per unit of cross-section of filter bed (X−Y gpm/Ft²) should be established within a range that optimizes removal for substances that are dissolved in the fluid at low concentration, yet not so high as to cause flooding, sinking or downward fluidization of the media. The depth of the microbead filter bed should be at least 0.5 meters. Preferably, to maximize the overall efficiency of the treatment process, the depth of the filter bed is 1.5 to 3 meters.

A bio-film containing aerobic or anaerobic bacteria forms on the surface of the microbeads and acts to bio-convert pollutants within the fluid. The biofilter will generally contain a heterogeneous population, which includes autotrophic nitrifying bacteria such as Nitrosomonas spp, Nitrobacter spp or Nitrospira spp; and carbon oxidizing bacteria such as Proteobacteria if operated under aerobic conditions. Denitrification via methanotrophs, such as Pseudomonas spp, such as Pseudomonas putida, actively contributes to the biological degradation of Phenolic compounds.

The filter system 100 includes a collection plate 122 designed to control the water level 124 and prevent media from escaping from the filter. The collection plate 122 provides a controlled water depth upon which the microbead bed 112 is floated. The degree to which the bed 112 is submerged is calculated based on (i) the hydraulic loading rate, (ii) the size of the beads used, and (iii) the extent of biofilm growth and fouling within the void spaces between the beads. The collection plate 112 should provide a sufficient depth of water, which limits the extent to which the microbeads 112 are submerged to avoid the transport of the beads out of the filter. The collection plate 122 can also facilitate the movement of the microbeads to the media inlet 126 of the mixing device. In particular, the collection plate should allow the microbeads to move horizontally within the submerged zone (below the trickling portion of the bed) toward the media inlet 126. The media inlet 126 provides an entrance to the mixing device or stirring system.

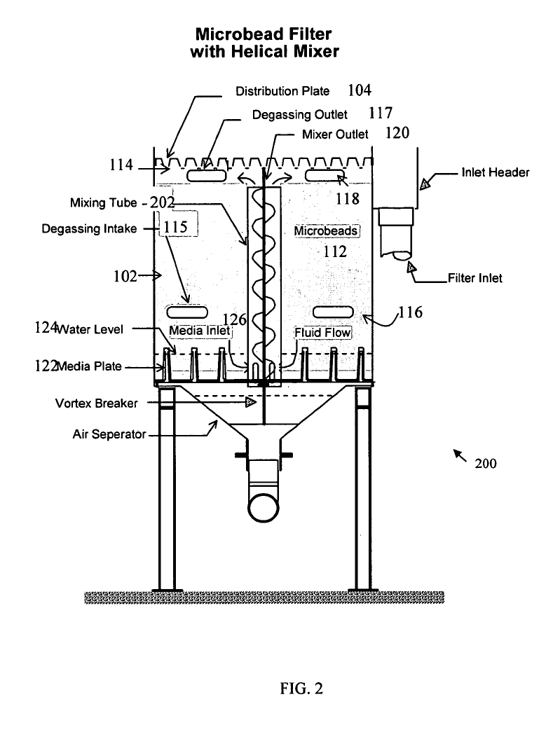

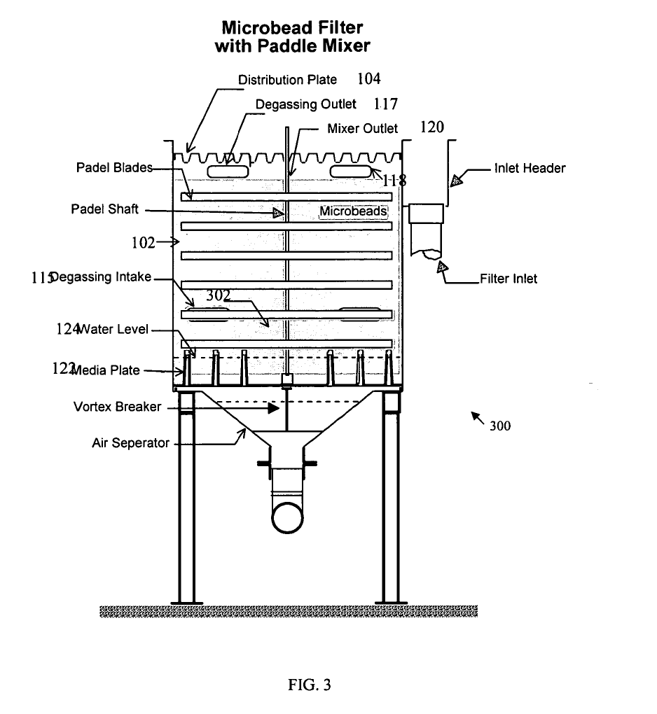

The mixing device is designed to minimize channeling and facilitate the transport and removal of excess biofilm and fine solids that are captured within the biofilm. The mixing device shown in FIG. 1 is an airlift or axial flow pump 110. Other mixing devices include augurs 202 or axial flows 302 as shown in FIGS. 2 and 3. Each mixing device has respective discrete collection points.

Referring to FIG. 1, the airlift pump 110 is integrated into the media bed 112. The airlift pump 110 continuously shears excess biomass and facilitates transport and removal from the filter 100. The upward movement of the media within the pump 110 exposes the media 112 to forces that separate a portion of the captured particles and excess biomass from the media 112. The microbeads are moved upward within the pump 110 to vertically mix and clean the beads. Once the media is deposited at the mixer outlet 120 at the top of the filter bed 112, it is rinsed via exposure to the sprayed influent. Because the solids laden microbeads are less buoyant, they tend to migrate to the bottom of the bed where they move laterally to the pump 110 entrance at the media inlet 126, facilitating a continuous or intermittent rinse process, which can be timed to match the loading rate of the influent.

FIG. 2 is a schematic depicting a microbead filter 200 with a helical mixer 202. One or more helical augurs 202 are placed within the bed 112. As the augers 202 rotate, a portion of the microbeads that are submerged at the bottom of the filter bed enter the media inlet 126 to the auger 202 and are transported by the auger 202 to the mixer outlet 120. At the mixer outlet, which is at the top of the bed 112, the microbeads are deposited within the plenum space 114 above the media 112.

The transport of the media within the augur 202 exposes the media to shear forces, which can be enhanced via an integrated rinsing system associated with the distribution plate 104, that are effective in removing a portion of the captured particles and excess biomass from the media. In addition, the water distribution system effectively rinses the media by continuously exposing a suitable portion of the beads to the sprayed influent water. Because most solid-laden beads are less buoyant, they tend to migrate to the bottom of the bed. The auger 202 establishes continuous movement and cleansing of the beads that can be balanced with the growth and accumulation of biosolids within the filter 200.

FIG. 3 is a schematic depicting a microbead filter 300 with a paddle mixer 302. In this embodiment, the stirring device is paddle mixer 302 that mixes the filter bed 112. The rotation of the mixer 302 serves the same function as the auger 202 of FIG. 2, continuously agitating and lifting the beads 112 within the filter 300. The combination of direct agitation and exposure to spray, which influences water that enters via the distribution plate 104, is an effective means of removing biosolids. The stirrer 302 provides contact between the biosolids removal process and the beads within the filter bed. Contact may be provided for a substantial amount of the beads or all of the beads.

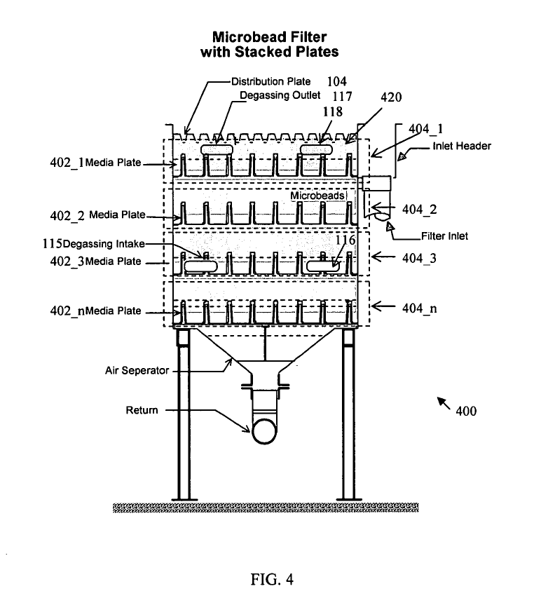

FIG. 4 is a schematic depicting a microbead filter 400 with stacked plates 402_1, . . . ,402_n. The series of stacked distribution or media plates 402_1, . . . ,402_n create a series of stacked shallow beds to achieve the targeted mass of ammonia removal. Water enters the microbead filter 300 via distribution plate 104, which establishes uniform flow through the bed. Media plates 402_{—1}, . . . ,402_n provide a gas-tight seal above each area of the filter bed and creates a series of stacked chambers 404-1, . . . ,404-n. The influent, as it enters the filter, dislodges and transports solids through a modest bed depth.

The aeration/degassing function is accomplished by operating within a specific hydraulic range that preserves a sufficient void fraction and by integrating ports through which an oxygen-containing gas is introduced into the microbead to displace undesirable gases that are to be removed. One or more exhaust ports 117, 118 are located within the plenum 420 to draw air from the filter vessel 102. The degassing sections 117, 118, may also include a means for recovering biologic filtering media from the water, such media being a residue of a treatment on the water prior to entering the unit. The filter 400 may also include a concentrator section. Water passes from the degassing section into the concentrator section. At the concentrator section, one or more screened intake ports 115, 116 may be provided to introduce air. The concentrator section may, for example, be a U-tube or a down-hole bubble concentrator or a low head oxygenator. Oxygen is mixed with the water at the entrance to the u-tube and travels with the flow to the bottom of the water column.

The use of multiple stacked media plates 402_1, 402_2, . . . ,402_n enables the integration of different gas removal or gas addition processes to be achieved within different chambers of the device 100. For example, within a filter containing multiple stacked chambers, with each chamber containing a plenum and a 0.3 meter deep bed, the upper chambers can be used for removal of dissolved CO₂, while the lower chambers can be used for the addition of oxygen. In this embodiment, a relatively high gas:liquid ratio would be used in the upper chambers 404-1, 404-2, with air being introduced 115, 116 in the lower chambers 404-3, 404-n, and being drawn up through the upper chambers 404-1, 404-2, prior to being exhausted 117, 118 out of the system 100. Pure oxygen or ozone could be introduced into the lower chambers 404-3, 404-n through the intake ports 115, 116, with modest pressurization (1 psi) being used to increase mass transfer and transfer efficiency.

It should be noted that because this approach to mixing using stacked media plates 402_1, 402_2, 402_3, 402_4 does not rely on mechanical agitation, it is particularly suitable for filters of relatively small size.

While this invention has been particularly shown and described with references to preferred embodiments thereof, it will be understood by those skilled in the art that various changes in form and details may be made therein without departing from the scope of the invention encompassed by the appended claims. For example, although specific sizes and properties are described for microbeads, it will be appreciated by those of ordinary skill in the art that any microbeads, which are calculated to achieve the same purpose may be substituted for the specific microbeads described herein. In addition, although the filters described herein are discussed in connection with a water treatment system for aquaculture, the specific filters may be used in connection with any treatment system. While specific embodiments of the system are directed to water treatment, other embodiments of the invention can be used for chemical, physical chemical, biological processes, and combinations thereof.

1. A filtration system, comprising:
a) a vessel having a deep bed filter of microbeads to filter a fluid that passes through the vessel;
b) a mixer within the vessel that mixes the microbeads; and
c) a distribution system that distributes the fluid into the deep bed filter.

2. A filtration system according to claim 1 wherein the deep bed filter further includes an exchange system that exchanges gasses in the fluid.

3. A filtration system according to claim 2 wherein the exchange system further includes a degassing system.

4. A filtration system according to claim 3 wherein the degassing system further includes at least one of the following: a spray tower, a drip tower or a packed tower.

5. A filtration system according to claim 2 wherein the exchange system further includes an oxygenation system.

6. A filtration system according to claim 2 wherein the exchange system further recovers residue derived from the fluid.

7. A filtration system according to claim 1 wherein the deep bed filter has a depth of at least about 0.5 meters.

8. A filtration system according to claim 1 wherein the distribution system further includes serial distribution plates to support the deep bed filter.

9. A filtration system according to claim 8 wherein the distribution plates are modified to provide substantially uniform flow of the fluid through the deep bed filter.

10. A filtration system according to claim 1 wherein the mixer further includes at least one of the following: stirrers, axial flow pump, airlift pumps or helical screws.

11. A filtration system according to claim 10 wherein the mixer is modified to prevent blockage of the fluid in the deep bed filter.

12. A method of filtering a fluid, comprising:
providing a deep bed filter of microbeads;
mixing microbeads in the deep bed filter; and
distributing the fluid through the deep bed filter of microbeads to provide a filtered fluid.

13. A method of filtering as in claim 12 wherein distributing the fluid through the deep bed filter of microbeads further includes exchanging gasses in the fluid by removing carbon dioxide from the fluid and adding oxygen to the fluid.

14. A method of filtering as in claim 13 wherein exchanging gasses displaces particles or biomass from the microbeads.

15. A method of filtering as in claim 13 wherein exchanging gases in the fluid further includes recovering residue from the fluid.

16. A method of filtering as in claim 12 wherein the deep bed filter has a depth of at least about 0.5 meters.

17. A method of filtering as in claim 12 wherein mixing the microbeads in the deep bed filter further includes moving the microbeads around using a stirrer or a pump.

18. A method of filtering as in claim 12 wherein mixing the microbeads further includes preventing blockage of the fluid in the deep bed filter.

19. A deep bed filter, comprising:
a housing;
a plurality of separation elements contained within the housing to divide the interior of the housing into chambers; and
each chamber supporting a filter bed of microbeads, where a fluid passes through one or more of the filter beds of microbeads providing deep bed filtration.

20. A method of filtering a fluid, comprising:
providing multiple stacked layers of microbead filter beds in a filter housing;
positioning a separation element between each layer of microbead filter beds; and
passing a fluid through one or more of the microbead filter beds to provide deep bed filtration.
